(19) United States
(12) Patent Application Publication
(10) Pub. No.: US 2015/0158619 A1
(43) Pub. Date: Jun. 11, 2015

(54) LABELLING UNIT FOR APPLYING A LABEL ONTO AN ARTICLE

(71) Applicant: Sidel S.p.A. con SOCIO UNICO, Parma (IT)

(72) Inventor: Antonio DEFLORIAN, Parma (IT)

(73) Assignee: Sidel S.p.A. con SOCIO UNICO

(21) Appl. No.: 14/567,519

(22) Filed: Dec. 11, 2014

(30) Foreign Application Priority Data
Dec. 11, 2013 (EP) 13196772.1

(51) Int. Cl. B65C 3/14; B65C 9/26; B65C 9/08

(52) U.S. Cl. CPC B65C 3/14; B65C 9/08; B65C 9/26

(57) ABSTRACT

A labelling unit comprises support means and a receiving member adapted to carry an article to be labelled and to receive a label, and supported by the support means in a translational and rotational manner with respect to an axis. The receiving member is movable along an axis between a raised position, in which it axially protrudes from the support means and is adapted to receive the article on its top portion and the label wrapped around its lateral wall, and a retracted position, in which it is housed within the support means so as to permit insertion of the article into the label welded in an endless configuration. The lateral wall of the receiving member comprises first suction means cooperating in use with a leading edge of the label, and second suction means cooperating in use with a remaining part of the label.

The present invention relates to a labelling unit for applying a label, in particular made of heat-shrinking film, on an article, such as a bottle or a generic container.

More specifically, the present invention relates to a labelling unit adapted to apply labels onto bottles or containers having non-circular cross-sections along planes orthogonal to their axes.

### BACKGROUND OF THE INVENTION

In greater details, the present invention relates to a labelling unit adapted to apply labels onto bottles or containers having oval cross-sections along planes orthogonal to their axes, which the following description will refer to, although this is in no way intended to limit the scope of protection as defined by the accompanying claims.

As it is generally known, the same type of labelling machine is currently used to apply tubular labels—commonly called “sleeve labels”—to containers or articles having circular or oval cross-sections along planes orthogonal to their axes.

These tubular labels are typically obtained by:
cutting the web unwound from a supply roll into a plurality of rectangular or square labels;
bending each label in a cylindrical configuration such that the opposite vertical edges overlap one another; and
welding the overlapped edges of each cylindrical label.

All these operations are normally performed on the labelling machine, which also produces insertion of containers into the so formed tubular labels.

A heat-shrinking step is then performed on the containers exiting from the labelling machine to obtain shrinking and adhesion of the label to the container external surface, being this surface cylindrical or annular with an oval cross-section along a plane orthogonal to its axis.

The labelling machine basically comprises a carousel rotating about a vertical axis to define a circular path, along which it receives a succession of unlabelled containers and, then, a succession of rectangular or squares labels from respective input wheels, produces application of the labels in a tubular configuration onto the respective containers and releases the labelled containers to an output wheel.

More specifically, the carousel comprises a number of labelling units which are equally spaced about the rotation axis, are mounted along a peripheral edge of the carousel and are moved by the latter along the above-mentioned circular path.

Each labelling unit comprises a bottom supporting assembly adapted to support the bottom wail of a relative container and an upper retainer adapted to cooperate with the top portion of such container to hold it in a vertical position during the rotation of the carousel about the vertical axis.

Each supporting assembly comprises a vertical hollow supporting mount, secured to a horizontal plane of a rotary frame of the carousel, and a cylindrical receiving member, engaging the supporting mount in sliding and rotating manner with respect to its axis, and adapted to carry a relative container on its top surface and a relative label on its lateral surface.

Each receiving member can be displaced between a raised position and a fully retracted position within the relative supporting mount.

In the raised position, each receiving member protrudes from a top surface of the relative supporting mount and is adapted to receive a relative label on its lateral surface from the label input wheel; in particular the label is wrapped around the receiving member such that the opposite vertical edges of the label overlap one another.

In order to produce this complete wrapping, the receiving member is rotated about its axis during the transfer of the label from the label input wheel.

In the fully retracted position, which is reached at the container input and output wheels, the top surface of each receiving member is flush with the top surface of the supporting mount so that containers are transferred onto and from the carousel along the same transfer plane,

After the welding of the overlapped edges of a tubular label, the displacement of the relative receiving member from the raised position to the fully retracted position produces the insertion of the relative container inside the label, making the so obtained container ready to be transferred to the output wheel.

Each label is retained on the lateral surface of the relative receiving member by suction; in particular, at least a region of the lateral surface of each receiving member is provided with a plurality of holes in turn connected to a pneumatic suction device.

In a completely analogous manner, each label is retained by suction on the label input wheel; during the transfer of the label from the label input wheel to the respective receiving member, suction is progressively cut on the label input wheel so that the label can be progressively released by the label input wheel and retained by suction on the receiving-member. This passage is quite critical as it should be performed by minimizing the possible tensions on the label while ensuring, at the same time, that a high retention force is exerted by the receiving member on the label to detach it from the label input wheel. An insufficient retention force exerted by each receiving member on the respective label during transfer may result, in an undesired displacement thereof with a consequent incorrect positioning of the label on the article to be labeled.

This problem is particularly felt in the case in which the label has to be applied on a container having a label receiving portion with oval cross-sections along planes orthogonal to its axis.

In addition, in this latter case, the cylindrical receiving member used on the labelling machine for wrapping the label in the tubular configuration must necessarily have a circular profile circumscribing the largest oval cross-section of the container. The following heat-shrinking step performed on the tubular label leads this label to take the external profile of the label receiving portion of the container.

However, by using this kind of technique, a considerable waste of material occurs, due to the fact that the label should have a sufficient size to be wrapped along a cylinder circumscribing the largest oval cross-section of the container.

In addition, the quality of the print—images or words—on the label may be negatively affected by the heat-shrinking step in the zones where the requested shrinkage is particularly high.

### SUMMARY OF THE INVENTION

It is an object of the present invention to provide a labelling unit, which allows to overcome at least one of the above drawbacks in a straightforward, and low-cost manner.

This object is achieved by a labelling unit, as claimed in claim 1.

### BRIEF DESCRIPTION OF THE DRAWINGS

A non-limiting embodiment, of the present invention will be described by way of example with reference to the accompanying drawings, in which:

FIG. 1 shows a schematic top plan view, with parts removed for clarity, of a labelling machine provided with a plurality of labelling units in accordance with the teachings of the present invention;

FIG. 2 shows a larger-scale top plan view of a part of the labelling machine of FIG. 1, in proximity of a label transfer station;

FIG. 3 shows a larger-scale view in perspective, with parts removed for clarity, of a labelling unit according to the present invention;

FIG. 4 shows a larger-scale view in perspective, with parts removed for clarity, of a part of the labelling unit of FIG. 3;

FIG. 5 shows a larger-scale section along line V-V in FIG. 3, with parts removed for clarity; and

FIGS. 6 to 9 show larger-scale top plan views of the labelling unit of FIG. 3 in different operating-conditions.

### DETAILED DESCRIPTION

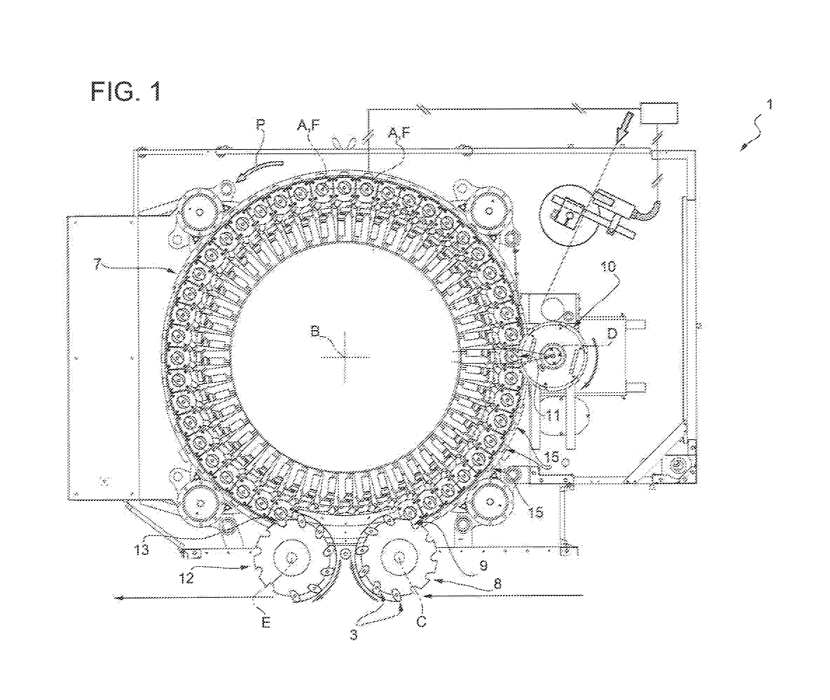

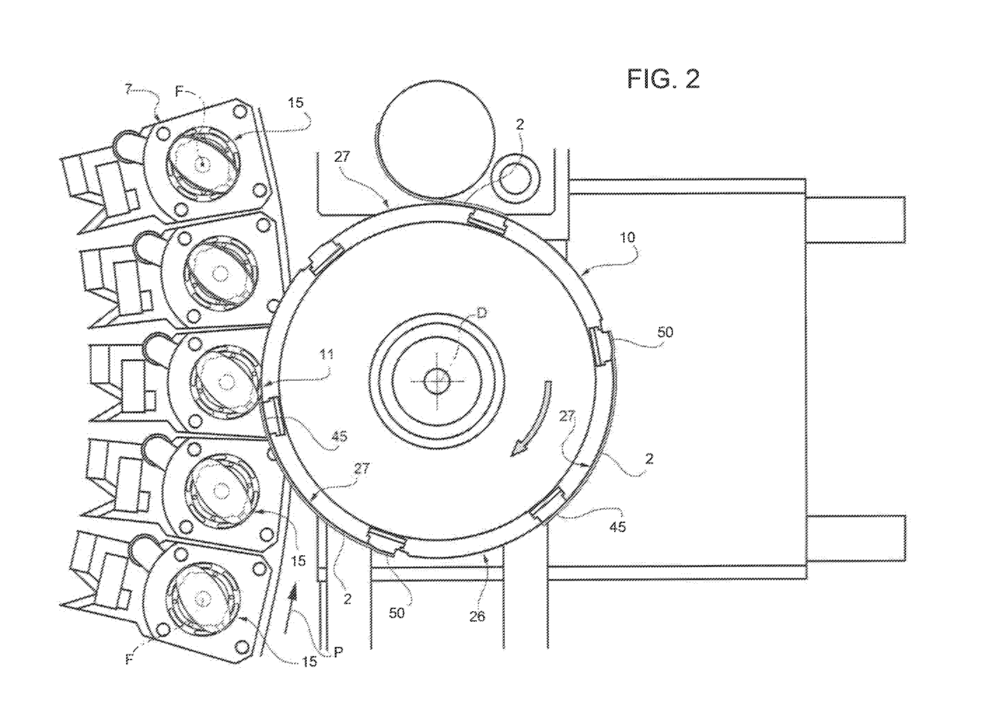

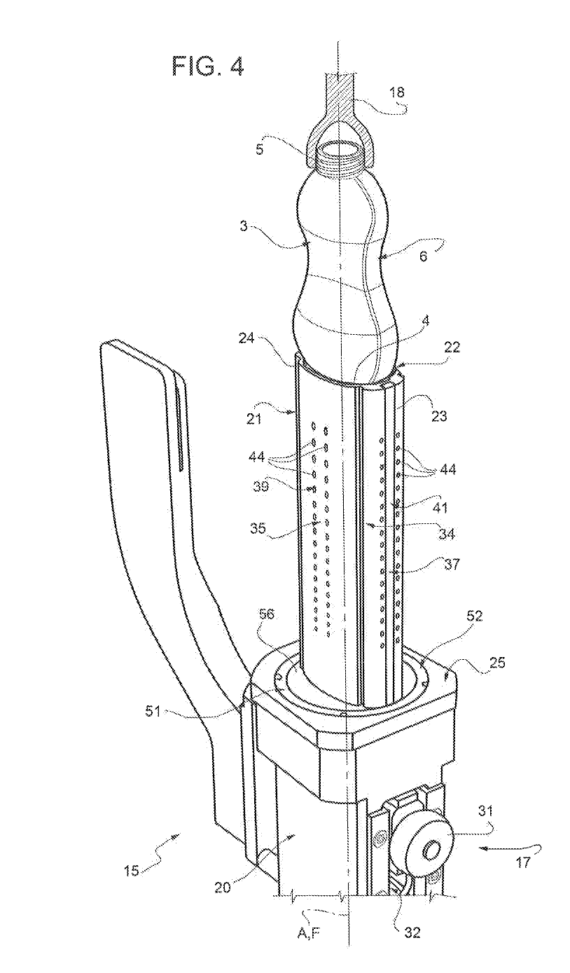

Number 1 in FIG. 1 indicates as a whole a labelling machine for applying labels 2 (FIGS. 2 and 5 to 9) to respective articles or more specifically containers, particularly bottles 3, each of which (FIGS. 1 and 4) has a given longitudinal axis A, is bonded at the bottom by a bottom wall 4 substantially perpendicular to axis A, and has a top neck 5 substantially coaxial with axis A.

Labelling machine 1 is in particular designed to apply a label 2 to a container or bottle 3 provided with a label receiving region 6 having an endless configuration about axis A and oval cross-sections along planes orthogonal to the axis A itself.

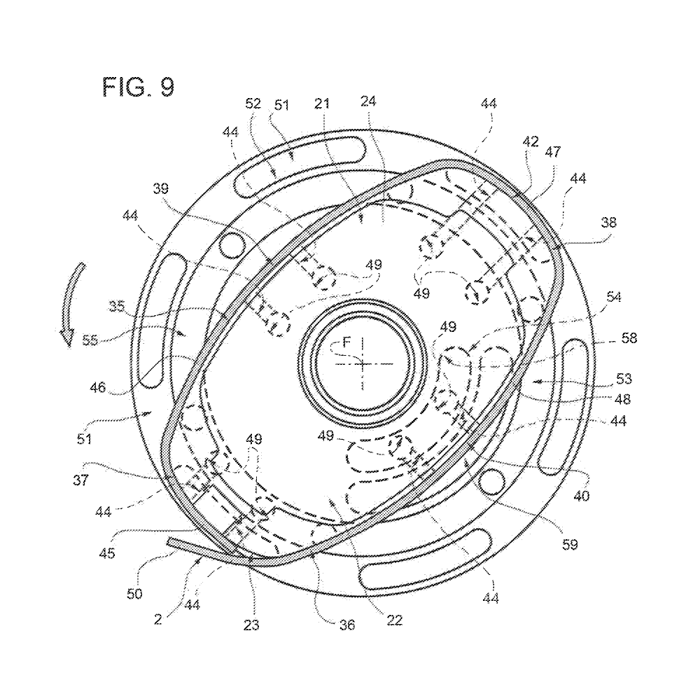

Machine 1 comprises a conveying device that serves to bend and weld labels 2 in a sleeve-like or endless configuration (FIGS. 2 and 9) and to produce insertion of bottles 3 into the so formed endless labels 2, while the labels 2 and the bottles 3 are continuously advanced.

In the preferred embodiment as illustrated in the FIGS. 1 and 2, the conveying device comprises a carousel 7, which is mounted to rotate continuously (anticlockwise in FIG. 1) about a vertical axis B perpendicular to the FIG. 1 plane.

The carousel 7 receives a succession of unlabelled bottles 3 from an input wheel 8, which cooperates with carousel 7 at a first transfer station 9 and is mounted to rotate continuously about a respective longitudinal axis C parallel to axis B.

The carousel 7 also receives a succession of rectangular or square labels 2 from an input drum 10, which cooperates with carousel 7 at a second transfer station 11 and is mounted to rotate continuously about a respective longitudinal axis D parallel to axes B and C.

The carousel 7 releases a succession of labelled bottles 3 to an output wheel 12, which cooperates with carousel 7 at a third transfer station 13 and is mounted to rotate continuously about a respective longitudinal axis E parallel to axes B, C and D.

The carousel 7 comprises a number of labelling units 15, which are equally spaced about axis B, are mounted along a peripheral edge of carousel 7, and are moved by carousel 7 along a circular path P extending about axis B and through transfer stations 9, 11 and 13.

As shown in FIG. 1, transfer station 11 is arranged, along path P, downstream from transfer station 9 and upstream from transfer station 13.

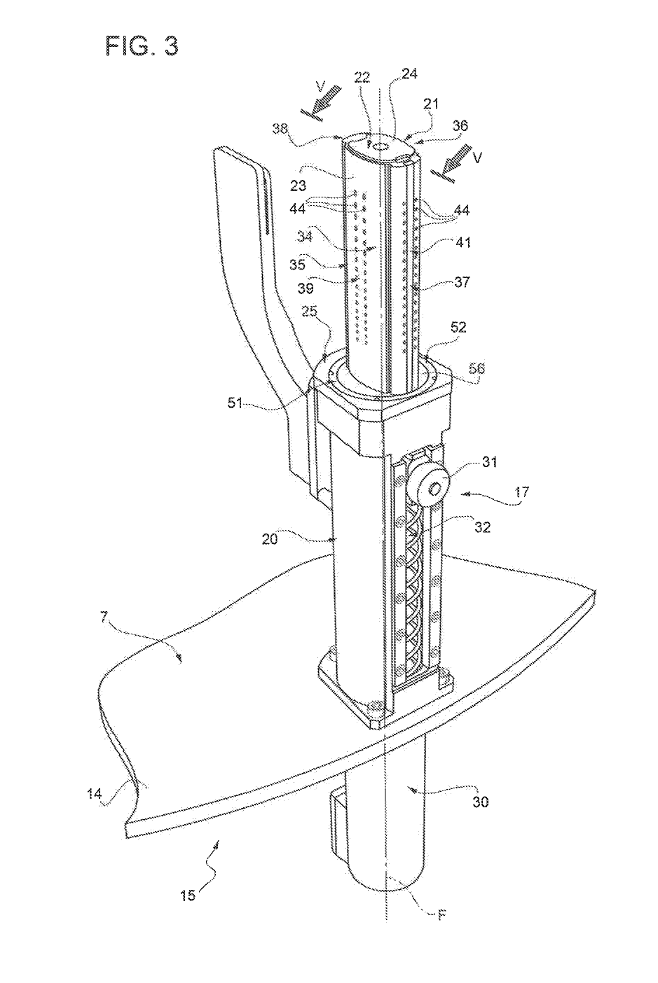

With reference to FIGS. 3 to 9, labelling units 15 are secured to a horizontal rotary table 14 of carousel 7, have respective axes F parallel to axes B, C, D, E and extend coaxially through respective holes (not shown) of the rotary table 14 and on both sides of such table.

Each labelling unit 15 is adapted to receive a relative bottle 3 from input wheel 8 in a vertical position, i.e. coaxially with the relative axis F (see in particular FIG. 4), and to hold said bottle 3 in such position along path P from transfer station 9 to transfer station 13.

Labelling units 15 being identical to each other, only one is described below for the sake of simplicity and clarity; it is clear that the features described hereafter are common to all labelling units 15.

In particular, labelling unit 15 comprises, above rotary table 14 of carousel 7, a supporting assembly 17 adapted, to support the bottom wall 4 of a relative bottle 3 and an upper retainer 18 (FIG. 4) adapted to cooperate with the top neck 5 of the bottle 3.

In particular, supporting assembly 17 comprises:
a hollow supporting mount 20 of axis F, which is secured to a top surface of rotary table 14 around the relative hole thereof; and
a hollow receiving member 21 coupled to the supporting mount 20 in a translational and rotational manner with respect to axis F, and adapted to carry coaxially a relative bottle 3 on its top end 22 and a relative label 2 on the outer surface of its lateral wall 23.

More specifically, the bottle 3 rests on a support plate 24, which is carried by top end 22 of receiving member 21 through the interposition of a relative bearing (not visible), so as to be angularly free from receiving member 21; in this way, rotational movements of receiving member 21 around axis F are not transmitted to the bottle 3.

Receiving member 21 can be moved along axis F between, a fully retracted position within the relative supporting meant 20 and a raised position (FIGS. 3 to 9).

In the fully retracted position, receiving member 21 is completely housed within the relative supporting mount 20 so that support plate 24 is flush with a top surface 25 of the supporting mount 20.

In the raised position, receiving member 21 protrudes from the top surface 25 of the supporting mount 20 and is adapted to receive, on the outer surface of its lateral wall 23, a relative label 2 from input drum 10,

More specifically, labels 2 are cut in a know manner from a web (not shown) and fed to input drum 10 to be then transferred to the respective receiving members 21 in the raised position.

As shown in FIG. 2, the cut labels 2 are retained on a lateral surface 26 of input drum 10 by suction; in fact, the lateral surface 26 of input drum 10 is divided into a given number, three in the embodiment shown, of suction regions 27, which are equally spaced about axis D, are each provided with a plurality of through holes (known per se and not shown) connected to a pneumatic suction device (known per se and not shown) and are adapted to cooperate with respective labels 2.

In a completely analogous manner and as it will be described hereafter in greater details (FIGS. 3 and 4), lateral wall 23 of receiving member 21 is adapted to retain a corresponding label 2 on its outer surface by suction.

At the transfer station 11, receiving member 21 can be rotated about the relative axis F in order to produce the complete wrapping of the respective label 2, coming from input drum 10, on the outer surface of its lateral wall 23. In particular, each label 2, fed by input drum 10, is wrapped around the corresponding receiving member 21 in the raised position so as to form a sleeve or an endless sheet.

As it appears from above, receiving member 21, during its travel along path P with the other components of labelling unit 15, is subjected to distinct movements in different operative steps of the labelling machine 1:
a displacement along axis F from the fully retracted position to the raised position, after a bottle 3 has been transferred to labelling unit 15;
a rotational movement about axis F to receive a relative label 2 from input drum 10 and to allow bending of such Label in an endless or sleeve configuration; and
a displacement from the raised position to the fully retracted position to allow insertion of the bottle 3 within the label 2 welded in the endless or sleeve configuration.

The rotational movement is obtained by means of an actuator assembly 30 (known per se and only schematically shown in FIG. 3) arranged underneath rotary table 14 and secured to a bottom surface of the rotary table 14 itself.

Actuator assembly 30 comprises a driving shaft (not shown) extending coaxially through supporting mount 20 and rotationally coupled to receiving member 21.

The translational displacements along axis F are instead obtained by cooperation of a fixed cam (known per se and not shown) extending along path P and a cam follower 31 coupled to receiving member 21 and protruding radially outwards from a vertical through slot 32 of supporting mount 20, i.e. from a slot extending parallel to axis F.

With reference to FIGS. 2 to 4 and 6 to 9, lateral wall 23 of receiving member 21 defines a label receiving portion 34 having an oval section along a plane orthogonal to axis F.

In particular, label receiving portion 34 comprises a pair of opposite side portions 35, 36, both having curved and convex shapes, and a pair of opposite edge portions 37, 38, also having curved and convex shapes and connecting side portions 35, 36 to one another; edge portions 37, 38 have smaller angular extensions around axis F than side portions 35, 36.

As visible in particular in FIGS. 3 and 4, portions 35, 36, 37, 38 of lateral wall 23 of receiving member 21 are provided with respective suction regions 39, 40, 41, 42 equally spaced angularly from one another with respect to axis F; in the example shown in FIGS. 3 and 4, each, suction region 39, 40, 41, 42 extends along the most part of the height of receiving member 21 and includes two vertical rows of suction holes 44.

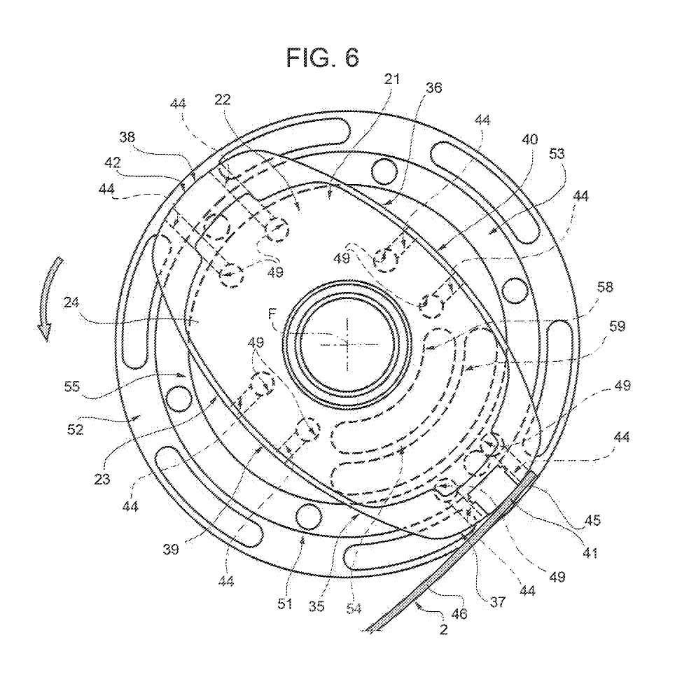

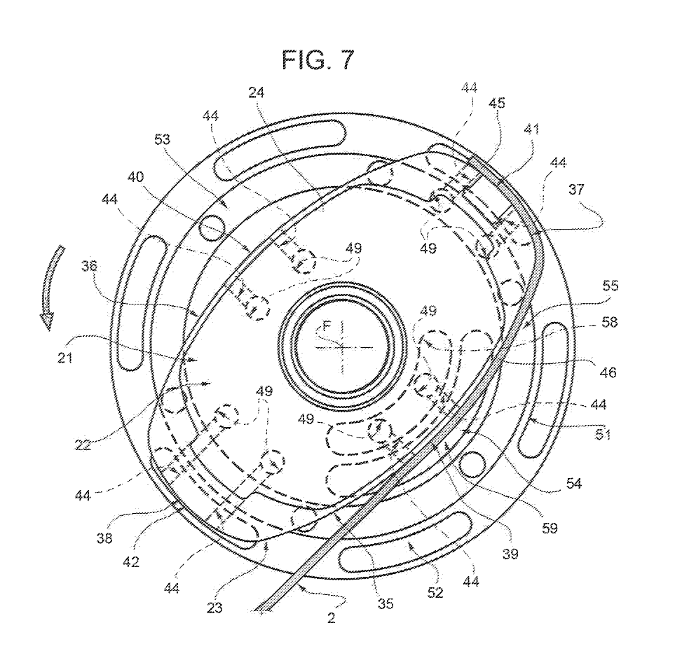

Suction region 41 is designed to cooperate in use with a leading edge 45 of label 2 (see FIG. 6), whilst the other suction regions 39, 42 and 40 are designed to respectively cooperate with corresponding next portions 46, 47, 48 of the label 2 as they progressively adhere to lateral wall 23 of receiving member 21 during transfer of such label 2 from input drum 10 (see FIGS. 7 to 9). At the end of the transfer, trailing edge 50 of label 2 is overlapped to leading edge 45 so that these opposite edges 45, 50 can be welded together to define the endless configuration of the label 2.

As visible in greater details in FIGS. 6 to 9, portion 46 of label 2 is adjacent to leading edge 45, portion 47 is adjacent to portion 46 and portion 48 is adjacent, on one side, to portion 47 and, on the opposite side, to trailing edge 50.

All suction regions 39, 40, 41, 42 of receiving member 21 are supplied in use by the same suction source (not shown).

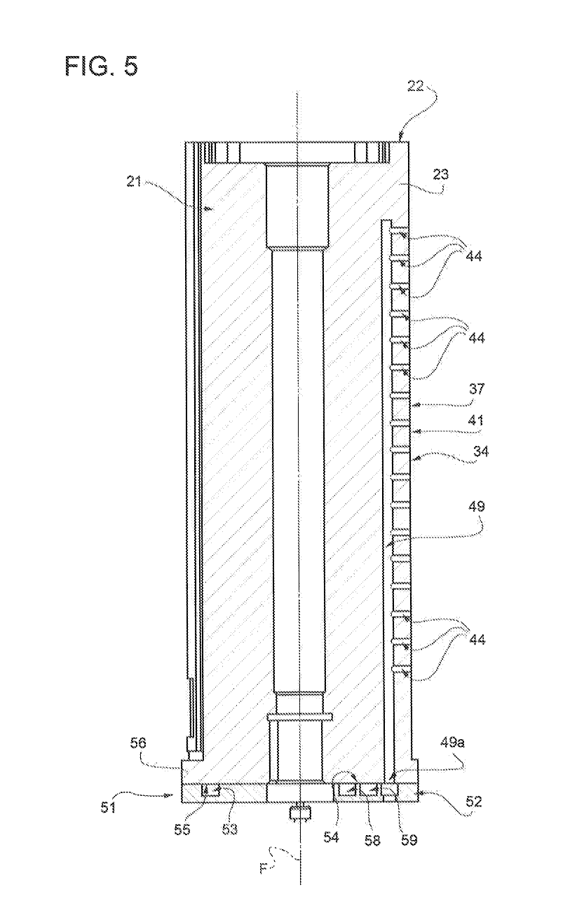

As visible in FIGS. 5 to 9, the holes 44 of each suction region 39, 40, 41, 42 are connected to a pair of vertical ducts 49—one duct 49 for each row of holes 44—extending through the body of lateral wall 23 of receiving member 21 in a direction parallel to axis F and open at the bottom of the receiving member 21 to define respective inlet mouths 49a (FIG. 5).

With reference to FIGS. 3 to 9, labelling unit 15 advantageously comprises control means 51 to activate suction region 41 prior to suction regions 39, 40, 42 during wrapping of label 2 around receiving member 21 so as to maximize the retention force on leading edge 45 of the label 2 at the beginning of the transfer of the latter onto receiving member 21.

In particular, control means 51 comprise a vacuum distribution member 52 connected to the suction source, carried by supporting mount 20 in a fixed angular position with respect to axis F and in turn including:
first supplying means 53 connected to suction region 41 of edge portion 37 of receiving member 21 in any angular position of the receiving member 21 about axis F; and
second supplying means 54 progressively and selectively connected, in use to suction regions 39, 42, 40 of portions 35, 38, 36 of receiving member 21 as a result of the rotation of the receiving member 21 about axis F and with respect to the distribution member 52, starting from, a condition in which the leading edge 45 of the label 2 has completed Its adhesion onto the edge portion 37.

Distribution member 52 is arranged at the base of receiving member 21 in a position interposed between the latter and supporting mount 20 and has a cylindrical configuration so that it can slide within the supporting mount 20 along axis F.

Receiving member 21 is angularly movable with respect to distribution member 52 about axis F and is displaceable together with the distribution member 52 along the axis F itself.

In the example shown in FIGS. 5 to 9, supplying means 53 comprise one annular outlet groove 55 provided on top of distribution member 52 and coaxial with axis F; the inlet mouths 49a of ducts 49 of suction region 41 move along and above annular outlet groove 55 during rotation of the receiving member 21 about axis F; in this way, a continuous connection is established between supplying means 53 of distribution member 52 and suction region 41 of receiving member 21 during rotation of the latter about axis F.

It should be noted that, at its bottom end, receiving member 21 is provided with a radially protruding annular flange 56 covering in use the top of distribution member 52 and angularly movable with the receiving member 21 about axis F.

Supplying means 54 comprise one or more arc-shaped outlet grooves, two in the example shown, indicated respectively with references 58, 59, which are provided on top of distribution member 52 and have angular extensions about axis F smaller than that of outlet groove 55. In particular, arc-shaped outlet groove 58 is radially inner than outlet groove 59, in turn radially inner than annular groove 55. More specifically, both arc-shaped grooves 58, 59 have angular extensions smaller than 180° about axis F; in addition, the radially inner arc-shaped groove 58 has an angular size smaller than that of arc-shaped groove 59.

During wrapping of label 2 around receiving member 21, the inlet mouths 49a of ducts 49 of suction region 39 move along and above arc-shaped groove 58 as the suction region 39 respectively cooperates with portion 46 of the label 2 (see FIG. 7).

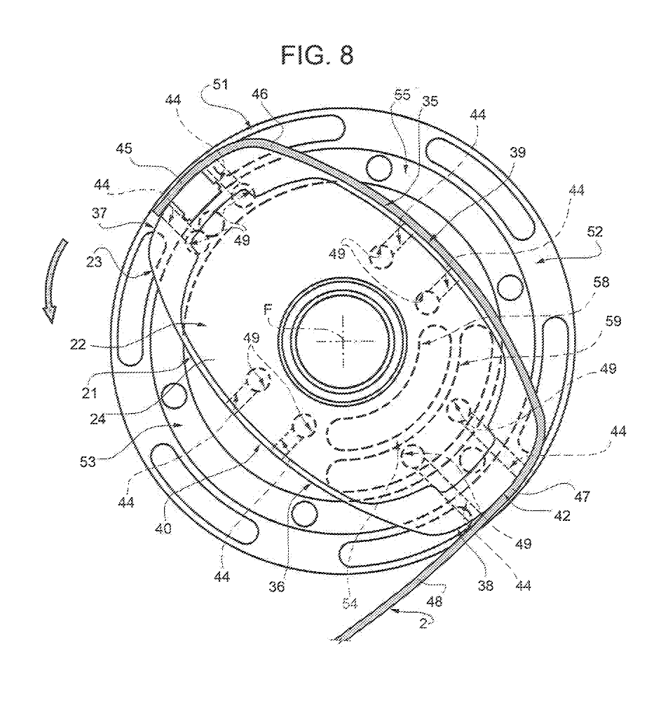

In a completely analogous manner, by proceeding with the wrapping of label 2 around receiving member 21, the inlet mouths 49a of ducts 49 of suction region 42 move along and above arc-shaped groove 59 as the suction region 42 respectively cooperates with portion 47 of the label 2 (see FIG. 8).

During the final stage of the wrapping of label 2 around receiving member 21, the inlet mouths 49a of ducts 49 of suction region 40 move along and above arc-shaped groove 58 as the suction region 40 respectively cooperates with portion 48 of the label 2 (see FIG. 9).

In practice, suction regions 39, 42, 40 are progressively and selectively activated as they cooperate with corresponding portions 46, 47, 48 of label 2 during wrapping thereof around receiving member 21.

It is also pointed out that, in a preferred embodiment of the present invention, each suction region 39, 42, 40 is deactivated as the next suction region 42, 40, 41 in the wrapping direction of label 2 about axis F starts to cooperate with the corresponding portion 47, 48, 50 of the label 2. In other words, during the wrapping operation, suction region 39 is deactivated as the next suction region 42 starts to cooperate with the corresponding portion 47 of the label 2; in a similar way, suction region 42 is deactivated as the next suction region 40 starts to cooperate with the corresponding portion 48 of the label 2; and finally, suction region 40 is deactivated as the next suction region 41 starts to cooperate with the trailing edge 50 of the label 2,

Operation of labelling machine 1 will now be described with reference to the labelling of one bottle 3, and therefore to one labelling unit 15, and as of the instant in which the receiving member 21 of such labelling unit 15 is in the fully retracted position within, the relative supporting mount 20 and has just received the unlabelled bottle 3 from input wheel 8.

In this condition, the bottle 3, which rests on plate 24 carried by the receiving member 21, is hold in the vertical position by the combined action of the receiving member 21 and the respective upper retainer 18 (FIG. 4).

During the subsequent movement of unit 15 along path P, interaction of cam follower 31 with the fixed cam (not shown) extending along path P produces in a known manner a translational movement of the receiving member 21 along axis F towards the desired raised, position (FIGS. 3 to 9).

At the transfer station 11, the input drum 10 reaches an angular position around axis D adapted to put the label 2 into contact with, the receiving member 21 passing through such station; in this condition, a pure rotational movement of receiving member 21 around axis F is required to produce complete wrapping of the label 2 in a known manner around such receiving member 21 (FIGS. 6 to 9).

In particular, as the leading edge 45 of the label 2 cooperates with edge portion 37 of lateral wall 23 of receiving member 21, the corresponding suction region 41, which is the only one active in this stage, exerts a retaining force on such leading edge 45 so as to maintain it in contact with the receiving member 21 (see FIG. 6). In particular, during this step, the inlet mouths 49a of suction region 41 move along and above annular outlet groove 55 of distributor member 52 so as to maintain the holes 44 of such suction region 41 continuously supplied by the suction source; the outlet grooves 58, 59 of distributor member 52 are instead not connected to the other suction regions 39, 40 and 42.

Once leading edge 45 of label 2 has completed its adhesion to edge portion 37, the subsequent rotation of receiving member 21 about axis F with respect to distributor member 52 carries the inlet mouths 49a of the next suction region 39 to move along and above arc-shaped groove 58 (see FIG. 7); in this way, suction region 39 is activated to retain portion 46 of label 2 onto side portion 35 of receiving member 21.

Once portion 46 of label 2 also has completed its adhesion to side portion 35, the subsequent rotation of receiving member 21 about axis F with respect to distributor member 52 carries the inlet mouths 49a of the next suction region 42 to move along and above arc-shaped groove 59 (FIG. 8); in this way, suction region 42 is activated to retain portion 47 of label 2 onto edge portion 38 of receiving member 21. In the meantime, the rotational displacement of receiving member 21 about axis F to produce activation of suction region 42 also causes deactivation of suction region 39, since the corresponding inlet mouths 49a of this latter suction region are angularly spaced from both arc-shaped outlet grooves 58, 49.

Once portion 47 of label 2 also has completed its adhesion to edge portion 38, the subsequent rotation of receiving member 21 about axis F with respect to distributor member 52 carries the inlet mouths 49a of the next suction region 40 to move along and above arc-shaped groove 58 (FIG. 9); in this way, suction region 40 is activated to retain portion 48 of label 2 onto side portion 36 of receiving member 21, In the meantime, the rotational displacement of receiving member 21 about axis F to produce activation of suction region 40 also causes deactivation of suction region 42, since the corresponding inlet mouths 49a. of this latter suction region are angularly spaced from both arc-shaped outlet grooves 58, 49.

At the end of rotation of receiving member 21 about axis F, the label 2 reaches an endless or sleeve-like configuration with the opposite vertical edges 45, 50 overlapped one another.

At this point, the label 2 is ready to be welded along the edges 45, 50.

During the last part of the path P, the receiving member 21, together with distributor member 52, must be returned to the fully retracted position within the relative supporting mount 20, so as to produce the insertion of the bottle 3 inside the so formed endless label 2.

A heat-shrinking step (not shown) can be then performed on the bottles 3 exiting from carousel 7 to obtain shrinking and adhesion of the label 2 to tine bottle external surface.

The advantages of the labelling machine 1 and labelling units 15 according to the present invention will be clear from the above description.

Thanks to the fact that the suction region 41 of receiving member 21, designed to receive the leading edge 45 of label 2, is activated before the other suction regions 39, 40, 42 during the transfer of the label 2 from input, drum 10 to labelling unit 15, the retention force on such leading edge can be maximized, so avoiding undesired displacements of the label 2 with respect to the receiving member 21.

This maximization of the retention force on the leading edge 45 of the label 2 is particularly useful when such label 2 is applied to non-cylindrical receiving members, such as the receiving member 21 having an oval cross-section orthogonally to its axis F, In this way, in fact, the high retention force on the leading edge 45 of the label 2 permits the latter to withstand the tensions and stresses caused by non-constant peripheral speed of the non-cylindrical receiving member during its rotation about its axis to produce wrapping of the label; in addition, further tensions and stresses may be produced on each label 2 by the fact that the non-cylindrical receiving member does not have a constant distance from the input drum 10 during its rotation about its axis.

The applicant has also observed that this new concept of differentiated activations of the suction regions may be also advantageously applied to cylindrical receiving members, in solutions in which the forces required to detach the labels from, the input drum are particularly high.

Plus, the adoption of a receiving member 21 having an oval cross-section orthogonally to its axis F, corresponding to the largest oval cross-section of the bottle 3 to be labeled, permits to limit drastically the amount of plastic material used for each label 2.

Furthermore, the shrinkage applied to the label 2 to adhere to the label receiving portion 34 of the bottle 3 is very limited, with no negative consequence on the quality of the print present on the label 2.

Clearly, changes may be made to labelling machine 1 and labelling units 15 as described and illustrated herein without, however, departing from the scope of protection as defined in the accompanying claims.

1. A labelling unit for applying a label onto an article; said labelling unit comprising:
support means; and
a receiving member adapted to carry said article and to receive said label, and supported by said support means in a translational and rotational manner with respect to a unit axis;
wherein said receiving member is movable along said unit axis between:
a raised position, in which said receiving member axially protrudes from said support means, carries said article on a top portion and is adapted to receive said label wrapped around a lateral wall; and
a retracted position, in which said receiving member is housed within said support means so as to permit insertion of said article into the label welded in an endless or sleeve configuration;
wherein said lateral wall of said receiving member comprises first suction means cooperating in use with a leading edge of the label during wrapping thereof around the receiving member, and second suction means cooperating in use with a remaining part of the label during said wrapping;
wherein, during wrapping of said label around said receiving member, said first suction means are activated prior to said second suction means to maximize the retention force on said leading edge of said label at the beginning of the transfer of the latter onto said receiving member.

2. The labelling unit of claim 1, further comprising control means to activate said first suction means prior to said second suction means during wrapping of said label around said receiving member so as to maximize the retention force on said leading edge of said label at the beginning of the transfer of the latter onto said receiving member.

3. The labelling unit of claim 2, wherein said control means comprise a distribution member connected to a suction source, carried by said support means in a fixed angular position with respect to said unit axis and comprising:
first supplying means connected to said first suction means in any angular position of said receiving member about said unit axis; and
second supplying means progressively and selectively connected in use to said second suction means as a result of the rotation of said receiving member about said unit axis and with respect to said distribution member starting from a condition in which said leading edge of said label has completed its adhesion onto the portion of said lateral wall of said receiving member provided with said first suction means.

4. The labelling unit of claim 3, wherein said distribution member is arranged at the base of said receiving member, and wherein said receiving member is angularly movable with respect to said distribution member about said unit axis and is displaceable together with said distribution member along said unit axis.

5. The labelling unit of claim 3, wherein said first supplying means comprise an annular first outlet groove provided on top of said distribution member, and wherein said first suction means comprise at least a first inlet mouth formed in said receiving member and movable along and above said first outlet groove during rotation of said receiving member about said unit axis.

6. The labelling unit of claim 3, wherein said first suction means comprise a first suction region provided in the portion of the lateral wall of the receiving member cooperating in use with the leading edge of the label, and wherein said second suction means comprise a plurality of second suction regions, angularly spaced from one another and from said first suction region with respect to said unit axis and adapted to cooperate in use with corresponding portions of said label other than said leading edge.

7. The labelling unit as claimed in of claim 6, wherein said second suction regions are progressively and selectively activated as they cooperate with corresponding portions of said label during wrapping thereof around said receiving member.

8. The labelling unit of claim 7, wherein, during wrapping of said label around said receiving member, each of said second suction regions is deactivated as the next first or second suction region in the rotational direction starts to cooperate with the corresponding portion of the label.

9. The labelling unit of claim 1, wherein said lateral wall of said receiving member comprises a label receiving portion having an oval section orthogonally to said unit axis.

10. The labelling unit of claim 8, wherein said label receiving portion of said lateral wall of said receiving member comprises a first edge portion having a curved and convex shape and adapted to cooperate in use with the leading edge of said label, an opposite second edge portion also having a curved and convex shape, a first side portion and a second opposite side portion, both having curved and convex shapes; wherein said first suction region is formed into said first edge portion; and wherein said second suction regions are respectively formed into said second edge portion and said first and second side portion of the lateral wall of said receiving member.

11. The labelling unit of claim 6, wherein said second supplying means comprise one or more arc-shaped second outlet grooves provided on top of said distribution member and having angular extensions about said unit axis smaller than that of said first outlet groove; and wherein said second suction means comprise a plurality of second inlet mouths formed in said receiving member, connected to respective second suction regions and movable along and above the respective said second outlet grooves as said second suction regions respectively cooperate with corresponding portions of said label during wrapping thereof around said receiving member.

12. The labelling unit of claim 3, wherein said support means comprises a hollow supporting mount carrying said distribution member in a sliding manner along said unit axis and said receiving member in a translational and rotational manner with respect to said unit axis.

13. A labelling machine comprising a plurality of labelling units, as claimed in claim 1, and a conveying device for moving said labelling units along a given path orthogonal to the unit axis of each labelling unit.
